(19) United States
(12) Patent Application Publication
(10) Pub. No.: US 2013/0199190 A1
(43) Pub. Date: Aug. 8, 2013

(54) FUEL INJECTION ASSEMBLY FOR USE IN TURBINE ENGINES AND METHOD OF ASSEMBLING SAME

(71) Applicants: Jong Ho Uhm, Simpsonville, SC (US); Thomas Edward Johnson, Greer, SC (US); Chunyang Wu, Greer, SC (US)

(72) Inventors: Jong Ho Uhm, Simpsonville, SC (US); Thomas Edward Johnson, Greer, SC (US); Chunyang Wu, Greer, SC (US)

(21) Appl. No.: 13/368,702

(22) Filed: Feb. 8, 2012

(51) Int. Cl. F23R 3/28; B23P 11/00

(52) U.S. Cl. 60/740; 29/888

(57) ABSTRACT

A fuel injection assembly for use in a turbine engine is provided. The fuel injection assembly includes a plurality of tube assemblies wherein each of the plurality of tube assemblies includes a plurality of tubes. At least one injection system is coupled to at least one tube assembly of the plurality of tube assemblies. The injection system includes a fuel delivery pipe and a fluid supply member coupled to the fuel delivery pipe, wherein the fluid supply member is positioned a predefined distance upstream from the tube assembly and includes at least one first portion having an annular end portion. The annular end portion includes at least one opening for delivering fluid toward the tube assembly for reducing dynamic pressure oscillations and/or reducing the temperature within a combustor during operation of the turbine engine.

### FEDERAL RESEARCH STATEMENT

This invention was made with Government support under Contract No. DE-FC26-05NT42643, awarded by the Department of Energy (DOE), and the Government has certain rights in this invention.

### BACKGROUND OF THE INVENTION

The subject matter disclosed herein generally relates to turbine engines and, more particularly, to a fuel injection assembly for use in a turbine engine.

At least some known turbine engines are used in cogeneration facilities and power plants. Such engines may have high specific work and power per unit mass flow requirements. Such turbine engines may include at least one combustor that includes a plurality of fuel nozzles that may be coupled within a combustor. Compressed air flows through and past the nozzles to reach a combustion zone within the combustor. As the air travels through and past the fuel nozzles, fuel is injected into the airflow, and the air and the fuel mix together to produce a fuel-air mixture which is ignited in the combustion zone of the combustor. To increase the operating efficiency, at least some known turbine engines, such as gas turbine engines, operate with increased combustion temperatures. In at least some known gas turbine engines, engine efficiency increases as combustion gas temperatures increase.

However, operating with higher temperatures may also increase the generation of polluting emissions, such as oxides of nitrogen (NO_{X}). In an attempt to reduce the generation of such emissions, at least some known turbine engines include improved combustion system designs. For example, many combustion systems may use premixing technology that includes tube assemblies or micro-mixers that facilitate mixing substances, such as diluents, gases, and/or air with fuel to generate a fuel mixture for combustion. Premixing technology may also include a process known as hydrogen doping. In a hydrogen doping process, hydrogen gas (H₂) is mixed with fuel such that a fuel and hydrogen gas mixture is channeled to fuel nozzles. Hydrogen doping has been shown to reduce emission levels and helps reduce a combustor lean blow out (LBO).

However, micro-mixers that are symmetrically installed in a combustor and/or operating with high hydrogen gas levels may induce a screech tone frequency of greater than 1 kHz as the fuel is evenly dispersed within the micro-mixers.

Further, a screech frequency range greater than 1 kHz may result from a flame interaction between adjacent nozzles. Screech excitation induces mechanical vibrations throughout the combustion assembly and associated hardware components. Moreover, vibrations that are induced into the combustion system may increase the wear of the combustor and associated components, and/or may shorten the useful life of the combustion system.

### BRIEF DESCRIPTION OF THE INVENTION

In one embodiment, a fuel injection assembly for use in a turbine engine is provided. The fuel injection assembly includes a plurality of tube assemblies wherein each of the plurality of tube assemblies includes a plurality of tubes. At least one injection system is coupled to at least one tube assembly of the plurality of tube assemblies. The injection system includes a fuel delivery pipe and a fluid supply member coupled to the fuel delivery pipe, wherein the fluid supply member is positioned a predefined distance upstream from the tube assembly and includes at least one first portion having an annular end portion. The annular end portion includes at least one opening for delivering fluid toward the tube assembly for reducing dynamic pressure oscillations and/or the temperature within a combustor during operation of the turbine engine.

In another embodiment, a turbine engine is provided. The turbine engine includes a compressor and a combustion assembly coupled downstream from the compressor. The combustion assembly includes at least one combustor that includes at least one fuel injection assembly. The fuel injection assembly includes a plurality of tube assemblies wherein each of the plurality of tube assemblies includes a plurality of tubes. At least one injection system is coupled to at least one tube assembly of the plurality of tube assemblies. The injection system includes a fuel delivery pipe and a fluid supply member coupled to the fuel delivery pipe, wherein the fluid supply member is positioned a predefined distance upstream from the tube assembly and includes at least one first portion having an annular end portion. The annular end portion includes at least one opening for delivering fluid toward the tube assembly for reducing dynamic pressure oscillations and/or the temperature within the combustor during operation of the turbine engine.

In yet another embodiment, a method of assembling a fuel injection assembly for use with a turbine engine is provided. A plurality of tube assemblies are provided. Each of the plurality of tube assemblies includes a plurality of tubes. At least one injection system is coupled to at least one tube assembly of the plurality of tube assemblies. The injection system includes a fuel delivery pipe and a fluid supply member coupled to the fuel delivery pipe, wherein the fluid supply member includes at least one first portion having an annular end portion, and the annular end portion includes at least one opening for delivering fluid toward the tube assembly for reducing dynamic pressure oscillations and/or the temperature within the combustor during operation of the turbine engine. The fluid supply member is positioned a distance upstream from the tube assembly.

### BRIEF DESCRIPTION OF THE DRAWINGS

FIG. 1 is a schematic cross-sectional view of an exemplary turbine engine;

FIG. 2 is a schematic cross-sectional view of a portion of an exemplary fuel injection assembly that may be used with the turbine engine shown in FIG. 1 and taken along area 2;

FIG. 3 is an enlarged schematic upstream view of a portion of an exemplary injection system that may be used with the fuel injection assembly shown in FIG. 2 and taken along line 3-3;

FIG. 4 is an enlarged schematic cross-sectional view of a portion of an exemplary fluid supply member that may be used with the injection system shown in FIG. 3 and taken along line 4-4;

FIG. 5 is an enlarged schematic cross-sectional view of a portion of an alternative fluid supply member that may be used with the injection system shown in FIG. 3 and taken along line 4-4; and

FIG. 6 is an enlarged schematic cross-sectional view of a portion of an alternative fluid supply member that may be used with the injection system shown in FIG. 3 and taken along line 4-4.

### DETAILED DESCRIPTION OF THE INVENTION

The exemplary apparatus, systems, and methods described herein overcome at least some known disadvantages associated with at least some known combustion systems of turbine engines that induce vibrational energy therein and/or operate with high temperatures. The embodiments described herein provide a fuel injection assembly that may be used with turbine engines to facilitate substantially reducing the dynamic pressure oscillations and/or locally peak temperature within a combustor. The fuel injection assembly includes a plurality of tube assemblies wherein each of the plurality of tube assemblies includes a plurality of tubes. At least one injection system is coupled to at least one tube assembly of the plurality of tube assemblies. The injection system includes a fuel delivery pipe and a fluid supply member coupled to the fuel delivery pipe, wherein the fluid supply member is positioned a distance upstream from the tube assembly. The fluid supply member includes at least one first portion that includes at least one opening for delivering fluid toward the tube assembly for reducing dynamic pressure oscillations and/or locally peak temperature within a combustor during operation of the turbine engine. By delivering the fluid toward at least one of the tube assemblies, flame interactions within the tube assembly and/or between adjacent tube assemblies may be prevented by making uneven fuel distribution and diluting some portion of the fuel in the tube assembly, and the dynamic pressure oscillations and/or locally peak temperature may be reduced therein.

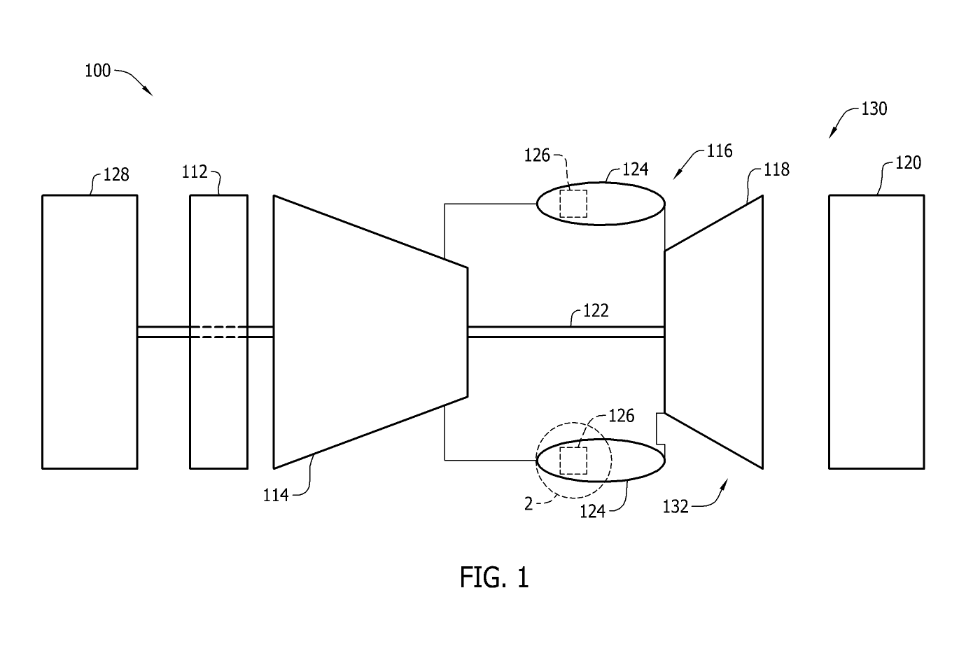

FIG. 1 is a schematic cross-sectional view of an exemplary turbine engine 100. More specifically, turbine engine 100 is a gas turbine engine. While the exemplary embodiment includes a gas turbine engine, the present invention is not limited to any one particular engine, and one of ordinary skill in the art will appreciate that the current invention may be used in connection with other turbine engines.

Moreover, in the exemplary embodiment, turbine engine 100 includes an intake section 112, a compressor section 114 coupled downstream from intake section 112, a combustor section 116 coupled downstream from compressor section 114, a turbine section 118 coupled downstream from combustor section 116, and an exhaust section 120. Turbine section 118 is coupled to compressor section 114 via a rotor shaft 122. In the exemplary embodiment, combustor section 116 includes a plurality of combustors 124. Combustor section 116 is coupled to compressor section 114 such that each combustor 124 is positioned in flow communication with the compressor section 114. A fuel injection assembly 126 is coupled within each combustor 124. Turbine section 118 is coupled to compressor section 114 and to a load 128 such as, but not limited to, an electrical generator and/or a mechanical drive application. In the exemplary embodiment, each compressor section 114 and turbine section 118 includes at least one rotor disk assembly 130 that is coupled to a rotor shaft 122 to form a rotor assembly 132.

During operation, intake section 112 channels air toward compressor section 114 wherein the air is compressed to a higher pressure and temperature prior to being discharged toward combustor section 116. The compressed air is mixed with fuel and other fluids that are provided by each fuel injection assembly 126 and ignited to generate combustion gases that are channeled toward turbine section 118. More specifically, each fuel injection assembly 126 injects fuel, such as natural gas and/or fuel oil, air, diluents, and/or inert gases, such as Nitrogen gas (N₂), into respective combustors 124, and into the air flow. The fuel mixture is ignited to generate high temperature combustion gases that are channeled toward turbine section 118. Turbine section 118 converts the thermal energy from the gas stream to mechanical rotational energy, as the combustion gases impart rotational energy to turbine section 118 and to rotor assembly 132. As described in more detail below, by having each fuel injection assembly 126 inject the fuel with air, diluents, and/or inert gases into respective combustors 124, dynamic pressure oscillations and locally peak temperature may be reduced within each combustor 124.

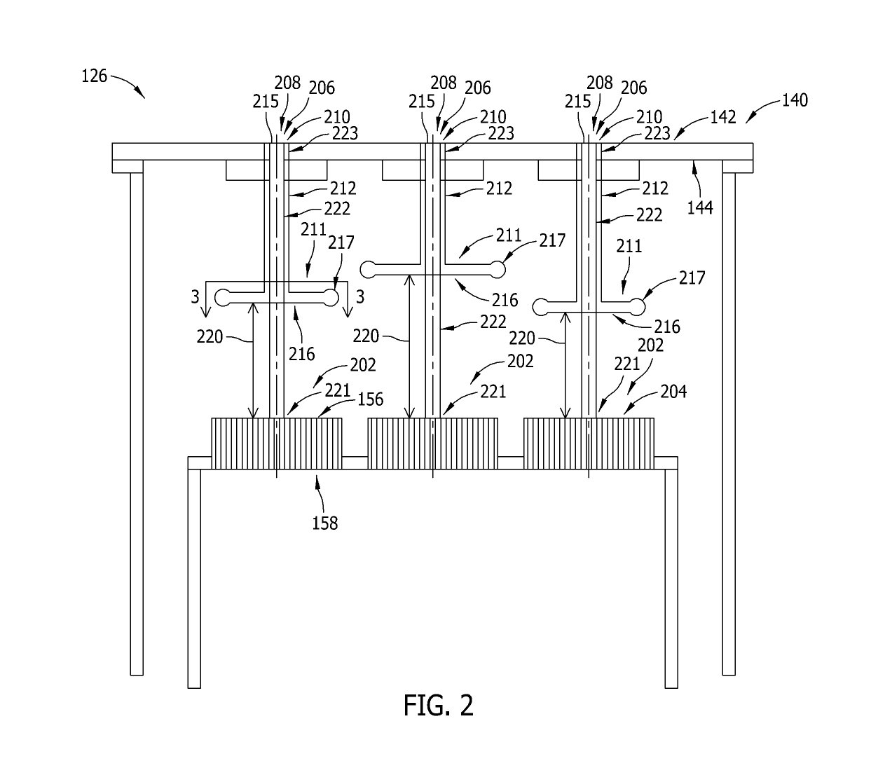

FIG. 2 is a cross-sectional view of a portion of fuel injection assembly 126 and taken along area 2 (shown in FIG. 1). In the exemplary embodiment, fuel injection assembly 126 extends from an end cover 140 of combustor 124 (shown in FIG. 1). In the exemplary embodiment, end cover 140 includes an upstream portion 142 and a downstream portion 144, wherein fuel injection assembly 126 extends from upstream portion 142 and through downstream portion 144. A plurality of tube assemblies 202 are coupled within combustor 124 and each tube assembly 202 includes an upstream portion 156 and a downstream portion 158. In the exemplary embodiment, tube assemblies 202 are fuel injection nozzles that are each substantially axially coupled within combustor 124. Tube assemblies 202 may be formed integrally within combustor 124 or tube assemblies 202 may be coupled to combustor 124. In the exemplary embodiment, each tube assembly 202 includes a plurality of tubes 204 that extend from upstream portion 156 to downstream portion 158. In the exemplary embodiment, each tube 204 discharges a mixture of fuel, air, and other fluids that are channeled through a passage (not shown) within each tube 204.

Fuel injection assembly 126 also includes at least one injection system 206. More specifically, in the exemplary embodiment, each tube assembly 202 is coupled to one injection system 206, and FIG. 2 illustrates three injection systems 206 that are coupled to three different tube assemblies. Injection system 206, in the exemplary embodiment, includes a fuel delivery pipe 208 and a fluid supply member 210 that is coupled to fuel delivery pipe 208 such that at least a portion of fluid supply member 210 substantially circumscribes at least a portion of fuel delivery pipe 208. Alternatively, fluid supply member 210 may be positioned in any other location with respect to fuel delivery pipe 208, such as adjacent to fuel delivery pipe 208, that enables fuel injection assembly 126 and/or turbine engine 100 (shown in FIG. 1) to function as described herein.

In the exemplary embodiment, fluid supply member 210 includes at least one first portion 211 extending from a second portion 212. A fluid source 215 is coupled to fluid supply member 210. More specifically, in the exemplary embodiment, fluid source 215 is coupled to second portion 212. Fluid source 215 may include an inert gas, air, and/or a diluent, such as Nitrogen gas (N₂), Carbon Dioxide (CO₂), fuel, and/or steam that may be used for reducing the probability of flameholding in fluid supply member 210. Fluid source may also include a fuel, such as a low reactive fuel, in fluid supply member 210. In the exemplary embodiment, fluid supply member second portion 212 has a substantially cylindrical shape such that fluid supply member second portion 212 substantially circumscribes a portion of fuel delivery pipe, and second portion 212 extends through end cover 140. Alternatively, fluid supply member second portion 212 may have any other shape that enables fuel injection assembly 126 and/or turbine engine 100 to function as described herein.

Fluid supply member second portion 212 extends downstream from end cover 140 to fluid supply member first portion 211. In the exemplary embodiment, a first end portion 216 of each fluid supply member first portion 211 extends from fluid supply member second portion 212. A second end portion 217 of each fluid supply member first portion 211 extends substantially radially outwardly from first end 216 of fluid supply member first end portion 211. In the exemplary embodiment, fluid supply member 210 is positioned a distance 220 upstream from tube assembly 202. Moreover, in the exemplary embodiment, distance 220 between each fluid supply member 210 and respective tube assembly 202 are substantially different from each other. Alternatively, distance 220 between each fluid supply member 210 and respective tube assembly 202 may be substantially the same or vary in any other suitable arrangement. More specifically, each first end portion 216 and second end portion 217 is positioned distance 220 upstream from tube assembly. In the exemplary embodiment, first portion 211 also includes at least one opening (not shown in FIG. 2) for delivering fluid toward tube assembly 202. More specifically, second end portion 217 of first portion 211 includes the opening for delivering fluid toward tube assembly 202. As described in more detail below, the size and shape of first portion 211 and/or second end portion 217 may vary such that fluid can be delivered toward tube assembly 202 and can be distributed to an annular ring portion (not shown) of tube assembly 202. For example, in the exemplary embodiment, each tube assembly 202 is substantially circular. As such, second end portion 217 is an annular ring such that fluid may be delivered toward tube assembly 202. Alternatively, tube assembly 202 may be any other suitable shape, such as a square or triangle, in which case second end portion 217 may have a different shape to adjust the fluid delivery towards the shape of tube assembly 202. By having fluid be delivered to tube assembly 202, the flame interaction between tube rows and between adjacent tube assemblies may be substantially reduced.

Fuel delivery pipe 208 in the exemplary embodiment includes a first end portion 221 that is coupled to tube assembly 202, a middle portion 222, and a second end portion 223 that is coupled to a fuel source (not shown). In the exemplary embodiment, fuel delivery pipe 208 has a substantially cylindrical shape. Alternatively, fuel delivery pipe 208 may have any other shape and/or size that enables fuel injection assembly 126 and/or turbine engine 100 to function as described herein.

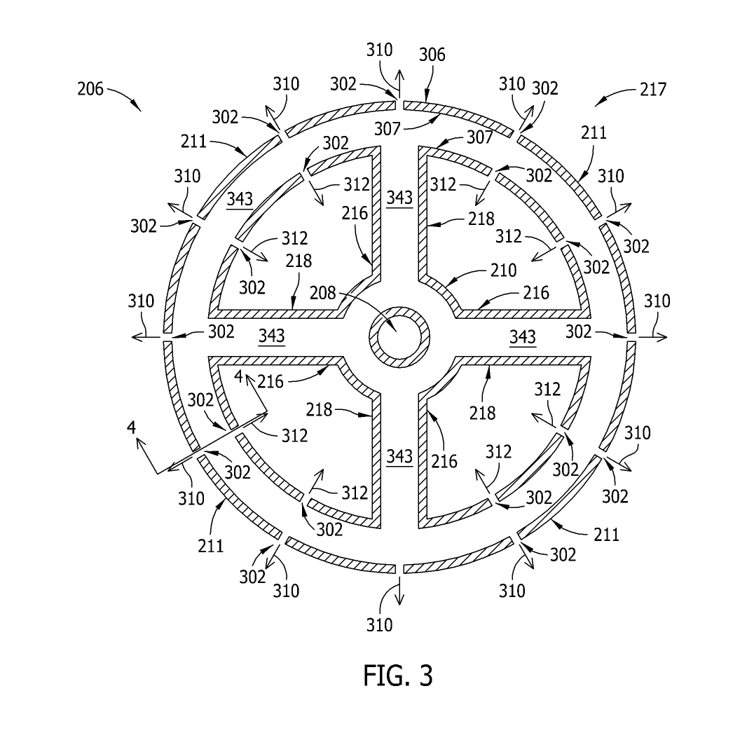

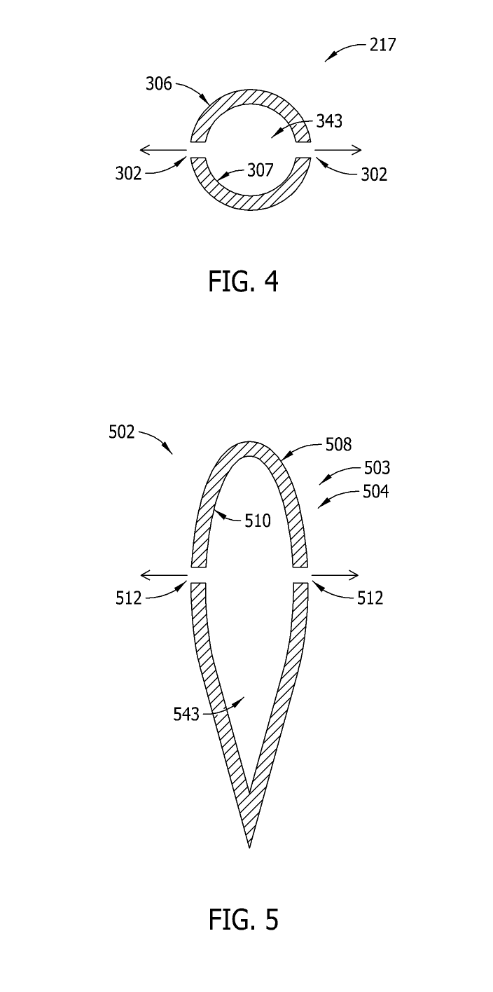

FIG. 3 is an enlarged schematic upstream view of a portion of injection system 206 and taken along line 3-3 (shown in FIG. 2). FIG. 4 is an enlarged cross sectional view of a portion of first portion 211 and taken along line 4-4 (shown in FIG. 3). Fluid supply member first portion 211 includes first end portion 216 and second end portion 217, wherein second end portion 217 is a hollow-annular ring that has a shape and size, such as a diameter size, that is substantially similar to tube assembly 202 (shown in FIG. 2). Alternatively, second end portion 217 may be any other shape and/or size to enable the injection system 206 to function as described herein. In the exemplary embodiment, second end portion 217 is connected with pipe supports 218 to channel fluid through a hollow interior portion 343 that defines flow passages in second end portion 217 such that fluid may then be channeled through at least one opening 302 defined within second end portion 217. More specifically, second end portion 217 includes openings 302 for delivering fluid toward tube assembly 202 (shown in FIG. 2).

In the exemplary embodiment, second end portion 217 includes an exterior surface 306 and an opposing interior surface 307, wherein openings 302 extend from exterior surface 306 to interior surface 307 for delivering fluid toward tube assembly 202. In the exemplary embodiment, openings 302 channel fluid in an outwardly direction from fluid supply member 210, as shown by arrows 310, and openings 302 may also channel fluid in toward fluid supply member 210, as shown by arrows 312. Alternatively, openings 302 may channel fluid in any other direction that enables fuel injection assembly 126 (shown in FIGS. 1 and 2) and/or turbine engine 100 (shown in FIG. 1) to function as described herein. As shown in FIG. 4, the hollow interior portion 343 of second portion 217 is substantially circular. Alternatively, the hollow interior portion 343 may have any other shape or size that enables fuel injection assembly 126 and/or turbine engine 100 to function as described herein.

During operation, fuel is channeled through fuel delivery pipe 208 (shown in FIG. 2) and supplied to tube assembly 202 (shown in FIG. 2), wherein the fuel is mixed with air to form a combustible mixture. By being positioned upstream from tube assemblies 202, fluid supply member 210 and the fluid that is channeled through openings 302 facilitates the distribution of the fuel over the tube assembly 202 such that the fuel may be unevenly dispersed in one tube assembly and all tube assemblies 202. Even heat release distribution through tube assemblies 202 may be avoided. For example, when fuel is supplied to tube assembly 202, fluids, air, inert gases, and/or diluents, such as N₂, CO₂, and/or steam is channeled within fluid supply member 210. More specifically, fluid is channeled from fluid source 215 (shown in FIG. 2) to fluid supply member second portion 212 (shown in FIG. 2). Fluid flows from second portion 212 to first portion 211. More specifically, fluid flows from second portion 212 to first end 216 of each fluid supply member first portion 211. Fluid then flows from first end 216 to second end 217 of each fluid supply member first portion 211, wherein fluid is channeled through each opening 302. The fluid flows away from or toward fluid supply member 210 and then toward tube assembly 202. When fluid flows toward tube assembly 202, the fluid facilitates an uneven fuel distribution and dilutes a portion of the fuel in tube assembly 202. Such uneven fuel distribution and dilution of the fuel in tube assembly 202 facilitates disrupting the flame interaction between the tubes 204 in one tube assembly 202 and between adjacent tube assemblies 202. For example, the fluid may disrupt the coupling interaction between a flame between adjacent tube assemblies 202. By substantially reducing such flame interactions, the temperature of tube assembly 202 is reduced, and the overall temperature of combustor 124 (shown in FIG. 1) is reduced. Further, by disrupting the flame interactions between tube assemblies 202, the fluid provides a barrier between adjacent tube assemblies 202. The barrier created by the fluid acts as a sound baffle for each tube assembly 202 supplied with fluid such that dynamic pressure oscillations within combustor 124 are reduced.

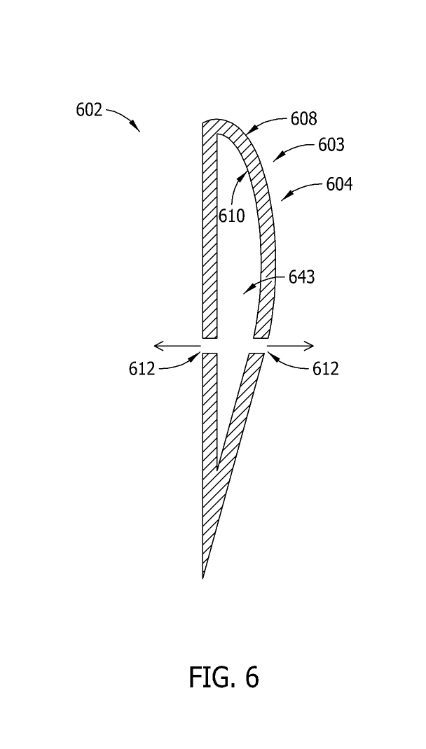

FIG. 5 is an enlarged schematic cross-sectional view of a portion of an alternative fluid supply member 502 that may be used with injection system 206 (shown in FIGS. 2 and 3) in place of fluid supply member 210 (shown in FIGS. 2, 3, and 4) and taken along line 4-4 (shown in FIG. 3). FIG. 6 is an enlarged schematic cross-sectional view of a portion of an alternative fluid supply member 602 that may be used with injection system 206 in place of fluid supply member 210 and taken along line 4-4 (shown in FIG. 3). Referring to FIG. 5, similar to fluid supply member 210, fluid supply member 502 includes at least one first portion 503 having a first end portion (not shown) and a second end portion 504.

In the exemplary embodiment, second end portion 504 has an exterior surface 508 and an opposing interior surface 510, wherein at least one opening 512 extends from exterior surface 508 to interior surface 510 for delivering fluid toward tube assembly 202 (shown in FIG. 2). Second end portion 504 is a hollow-annular ring connected with pipe supports 218 (shown in FIG. 3) to channel fluid through a hollow interior portion 543 that defines flow passages in second end portion 504 such that fluid may then be channeled through openings 512. In the exemplary embodiment, hollow interior portion 543 has a substantially full streamlined shape.

Referring to FIG. 6, similar to fluid supply member 210, fluid supply member 602 includes at least one first portion 603 having a first end portion (not shown) and a second end portion 604. In the exemplary embodiment, second end portion 604 has an exterior surface 608 and an opposing interior surface 610, wherein at least one opening 612 extends from exterior surface 608 to interior surface 610 for delivering fluid toward tube assembly 202 (shown in FIG. 2). Second end portion 604 is a hollow-annular ring connected with pipe supports 218 (shown in FIG. 3) to channel fluid through a hollow interior portion 643 that defines flow passages in second end portion 604 such that fluid may then be channeled through openings 612. In the exemplary embodiment, hollow interior portion 643 has a substantially half streamlined shape.

As compared to known apparatus and systems that are used with turbine engines, the above-described fuel injection assembly may be used with turbine engines to facilitate substantially reducing the dynamic pressure oscillations and/or reducing locally peak temperature, such as a locally peak temperature, within a combustor. The fuel injection assembly includes a plurality of tube assemblies wherein each of the plurality of tube assemblies includes a plurality of tubes. At least one injection system is coupled to at least one tube assembly of the plurality of tube assemblies. The injection system includes a fuel delivery pipe and a fluid supply member coupled to the fuel delivery pipe, wherein the fluid supply member is positioned a distance upstream from the tube assembly. The fluid supply member includes at least one first portion that includes at least one opening for delivering fluid toward the tube assembly for reducing dynamic pressure oscillations and/or locally peak temperature within a combustor during operation of the turbine engine. By delivering the fluid toward at least one of the tube assemblies, flame interactions within the tube assembly and/or between adjacent tube assemblies may be prevented by making uneven fuel distribution and diluting some portion of the fuel in the tube assembly, and the dynamic pressure oscillations and/or locally peak temperature may be reduced therein.

Exemplary embodiments of a fuel injection assembly and method of assembling same are described above in detail. The fuel injection assembly and method of assembling same are not limited to the specific embodiments described herein, but rather, components of the fuel injection assembly and/or steps of the injection assembly may be utilized independently and separately from other components and/or steps described herein. For example, the fuel injection assembly may also be used in combination with other machines and methods, and is not limited to practice with only a turbine engine as described herein. Rather, the exemplary embodiment can be implemented and utilized in connection with many other systems.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fuel injection assembly for use in a turbine engine, said fuel injection assembly comprising:
a plurality of tube assemblies wherein each of said plurality of tube assemblies comprises a plurality of tubes; and
at least one injection system coupled to at least one tube assembly of said plurality of tube assemblies, wherein said at least one injection system comprises a fuel delivery pipe and a fluid supply member coupled to said fuel delivery pipe, wherein said fluid supply member is positioned a predefined distance upstream from said at least one tube assembly and comprises at least one first portion comprising an annular end portion, wherein said annular end portion comprises at least one opening for delivering fluid toward said at least one tube assembly for reducing at least one of dynamic pressure oscillations and temperature within a combustor during operation of the turbine engine.

2. A fuel injection assembly in accordance with claim 1, wherein said fuel delivery pipe comprises a first end portion coupled within said at least one tube assembly.

3. A fuel injection assembly in accordance with claim 1, wherein said fluid supply member substantially circumscribes at least a portion of said fuel delivery pipe, said at least one first portion extends substantially radially outwardly from said fuel delivery pipe.

4. A fuel injection assembly in accordance with claim 1, wherein said at least one injection system comprises
a first injection system coupled to a first tube assembly and comprising a first fluid supply member positioned a first predefined distance upstream from said first tube assembly;
a second injection system coupled to a second tube assembly and comprising a second fluid supply member positioned a second predefined distance upstream from said second tube assembly; and
a third injection system coupled to a third tube assembly and comprising a third fluid supply member positioned a third predefined distance upstream from said third tube assembly, wherein the first predefined distance, the second predefined distance, and the third predefined distance are substantially different from each other.

5. A fuel injection assembly in accordance with claim 1, wherein said annular end portion comprises an exterior surface and an opposing interior surface, wherein said at least one opening extends from said exterior surface to said interior surface, said annular end portion has at least one of a substantially circular shape and a substantially streamlined shape.

6. A fuel injection assembly in accordance with claim 1, wherein each of said plurality of tube assemblies is a fuel nozzle.

7. A fuel injection assembly in accordance with claim 1, further comprising a fluid source coupled to said fluid supply member, wherein said fluid source contains at least one of fuel, air, an inert gas, and a diluent to be delivered toward said at least one tube assembly.

8. A turbine engine, said turbine engine comprising:
a compressor;
a combustion assembly coupled downstream from said compressor, wherein said combustion assembly comprises at least one combustor comprising a fuel injection assembly comprising:
a plurality of tube assemblies wherein each of said plurality of tube assemblies comprises a plurality of tubes; and
at least one injection system coupled to at least one tube assembly of said plurality of tube assemblies, wherein said at least one injection system comprises a fuel delivery pipe and a fluid supply member coupled to said fuel delivery pipe, wherein said fluid supply member is positioned a predefined distance upstream from said at least one tube assembly and comprises at least one first portion comprising an annular end portion, wherein said annular end portion comprises at least one opening for delivering fluid toward said at least one tube assembly for reducing at least one of dynamic pressure oscillations and temperature within said combustor during operation of said turbine engine.

9. A turbine engine in accordance with claim 8, wherein said fuel delivery pipe comprises a first end portion coupled within said at least one tube assembly.

10. A turbine engine in accordance with claim 8, wherein said fluid supply member substantially circumscribes at least a portion of said fuel delivery pipe.

11. A turbine engine in accordance with claim 8, wherein said at least one first portion extends substantially radially outwardly from said fuel delivery pipe, said annular end portion has at least one of a substantially circular shape and a substantially streamlined shape.

12. A turbine engine in accordance with claim 8, wherein said at least one injection system comprises:
a first injection system coupled to a first tube assembly and comprising a first fluid supply member positioned a first predefined distance upstream from said first tube assembly;
a second injection system coupled to a second tube assembly and comprising a second fluid supply member positioned a second predefined distance upstream from said second tube assembly; and
a third injection system coupled to a third tube assembly and comprising a third fluid supply member positioned a third predefined distance upstream from said third tube assembly, wherein the first predefined distance, the second predefined distance, and the third predefined distance are substantially different from each other.

13. A turbine engine in accordance with claim 8, wherein said annular end portion comprises an exterior surface and an opposing interior surface, wherein said at least one opening extends from said exterior surface to said interior surface.

14. A turbine engine in accordance with claim 8, wherein said fuel injection assembly further comprises a fluid source coupled to said fluid supply member, wherein said fluid source contains at least one of fuel, air, an inert gas, and a diluent to be delivered toward said at least one tube assembly.

15. A method for assembling a fuel injection assembly for use with a turbine engine, said method comprising:
providing a plurality of tube assemblies wherein each of the plurality of tube assemblies includes a plurality of tubes;
coupling at least one injection system to at least one tube assembly of the plurality of tube assemblies, wherein the at least one injection system includes a fuel delivery pipe and a fluid supply member coupled to the fuel delivery pipe, wherein the fluid supply member includes at least one first portion having an annular end portion, wherein the annular end portion includes least one opening for delivering fluid toward the at least one tube assembly for reducing at least one of dynamic pressure oscillations and temperature within a combustor during operation of the turbine engine; and
positioning the fluid supply member a predefined distance upstream from the at least one tube assembly.

16. A method in accordance with claim 15, wherein coupling at least one injection system further comprises coupling at least one injection system to the at least one tube assembly, wherein the at least one injection system includes a fuel delivery pipe that includes a first end portion coupled within the at least one tube assembly.

17. A method in accordance with claim 15, wherein coupling at least one injection system further comprises coupling the at least one injection system to the at least one tube assembly, the at least one injection system includes a fluid supply member coupled to the fuel delivery pipe such that the fluid supply member substantially circumscribes at least a portion of the fuel delivery pipe, the fluid supply member further includes at least one first portion that extends substantially radially outwardly from the fuel delivery pipe.

18. A method in accordance with claim 15, wherein coupling at least one injection system further comprises:
coupling a first injection system to a first tube assembly, wherein the first injection system includes a first fluid supply member positioned a first predefined distance upstream from the first tube assembly;
coupling a second injection system to a second tube assembly, wherein the second injection system includes a second fluid supply member positioned a second predefined distance upstream from the second tube assembly; and
coupling a third injection system to a third tube assembly, wherein the third injection system includes a third fluid supply member positioned a third predefined distance upstream from said third tube assembly.

19. A method in accordance with claim 18, wherein positioning the fluid supply member further comprises positioning each of the first fluid supply member, the second fluid supply member, and the third fluid supply such that the first predefined distance, the second predefined distance, and the third predefined distance are substantially different from each other.

20. A method in accordance with claim 1, further comprising coupling a fluid source to the fluid supply member, wherein the fluid source contains at least one of fuel, air, an inert gas, and a diluent to be delivered toward the at least one tube assembly.
